(19) United States
(12) Patent Application Publication
(10) Pub. No.: US 2018/0335860 A1
(43) Pub. Date: Nov. 22, 2018

(54) TOUCH DISPLAY SYSTEM, TOUCH DISPLAY METHOD, ACTIVE PEN, AND TOUCH CONTROL DEVICE

(71) Applicant: Silicon Integrated Systems Corp., Hsinchu City (TW)

(72) Inventors: Chin-Hua KUO, Hsinchu City (TW); Jiun-Ying YEH, Hsinchu City (TW); Hsin-Hsuan YU, Hsinchu City (TW); Ying-Jyh YEH, Hsinchu City (TW)

(21) Appl. No.: 15/968,951

(22) Filed: May 2, 2018

(30) Foreign Application Priority Data
May 16, 2017 (TW) 106116213

(51) Int. Cl. G06F 3/0354; G06F 3/041

(52) U.S. Cl. CPC G06F 3/03545; G06F 3/0412

(57) ABSTRACT

A touch display system includes a touch panel; a touch control chip configured to transmit a driving signal to the touch panel; an active pen configured to transmit a signal based on the driving signal of the touch control chip, the signal including two signal segments that are called a position signal and an ID signal, the touch control chip resolving the signal transmitted by the active pen to obtain an ID data carried by the ID signal and inquiring a property of the active pen corresponding to the ID data; and a display panel configured to display traces in accordance with the property of the active pen. Similar to the usage of a traditional marker pen, such an active panel is easily to be used by a user.

### BACKGROUND

### 1. Field of Disclosure

The present invention relates to touch control technologies, and more particularly to a touch display system, a touch display method, an active pen, and a touch control device.

### 2. Description of Related Art

Peripheral products have gradually developed alongside development of touch panels. One type is stylus. Existing styluses have more and more functions. In one aspect, an objective is to simulate a real pen. In existing arts, there are many buttons on the stylus. Each button can be defined as an adjustment of color or tip size, for example. Writing effects required to be carried out originally by different pens can be carried out with only one pen now. However, the existing styluses of this type mostly require BLUETOOTH to communicate with software installed on an operating system to be carried out. A learning process is needed for any consumer to use the existing styluses. This is a totally different experience from using a traditional marker pen or whiteboard pen. Intention to use the existing styluses is lowered.

Therefore, there is a need to provide a new touch display technology to solve above problems.

### SUMMARY

The objective of the present invention is to provide a touch display system, a touch display method, an active pen, and a touch control device, for solving the problem of inconvenient usage of a conventional stylus.

To achieve above objective, an aspect of the present invention provides a touch display system, including: a touch panel; a touch control chip configured to periodically transmit a first driving signal to the touch panel; an active pen including a signal transmitting portion and a signal receiving portion, the signal receiving portion configured to sense the first driving signal transmitted by the touch control chip from the touch panel to generate a first sensing signal, the signal transmitting portion configured to transmit a second driving signal when the first sensing signal exceeds a threshold, the second driving signal including at least a position signal and at least an identification (ID) signal, the touch panel configured to sense the second driving signal to generate a second sensing signal, the touch control chip configured to receive the second sensing signal from the touch panel, resolve the second sensing signal to obtain an ID data representative of the ID signal, and inquire a property of the active pen corresponding to the ID data; and a display panel configured to receive the property of the active pen from the touch control chip and display traces in accordance with the property of the active pen.

In another aspect, the present invention provides a touch display method, including: using a touch control chip to periodically transmit a first driving signal to a touch panel; using an active pen to sense the first driving signal transmitted by the touch control chip from the touch panel to generate a first sensing signal; using the active pen to transmit a second driving signal when the first sensing signal exceeds a threshold, the second driving signal including at least a position signal and at least an identification (ID) signal; using the touch panel to sense the second driving signal to generate a second sensing signal and receiving the second sensing signal from the touch panel; resolving the second sensing signal to obtain an ID data representative of the ID signal; inquiring a property of the active pen corresponding to the ID data; and based on the obtained property of the active pen, using a display panel to display traces in accordance with the property of the active pen.

In still another aspect, the present invention provides an active pen, including: a signal receiving portion configured to sensing a touch panel to generate a sensing signal; and a signal transmitting portion configured to transmit a driving signal when the sensing signal exceeds a threshold, wherein the driving signal includes a position signal and an identification (ID) signal which are two segments of the driving signal, and the ID signal is representative of an ID data corresponding to the active pen.

In yet another aspect, the present invention provides a touch control device, including: a touch panel; and a touch control chip configured to receive a sensing signal from the touch panel, the sensing signal generated by the touch panel, the touch control chip further configured to resolve the sensing signal to obtain an identification (ID) data of an active pen, and inquire a property of the active pen corresponding to the ID data.

In the present invention, the property of the active capacitive pen can be identified as long as the touch control chip cooperates with the active pen, without help of software. In this way, for example, the color, tip size, and/or type data stored in the active pen can be identified. The active pen of the present invention is comparable to a traditional marker or whiteboard pen. The usage of the active pen has no big change when it is compared to the usage of the traditional marker pen. This active pen is easily to be used by a user.

### BRIEF DESCRIPTION OF DRAWINGS

FIG. 1A is a schematic diagram showing a capacitive touch panel.

FIG. 1B is a schematic diagram showing coupling capacitance formed between a TX electrode and a RX electrode on a capacitive touch panel.

FIG. 1C is a schematic diagram showing a relation between coupling capacitance and ground capacitance on a capacitive touch panel.

FIG. 2A is a schematic diagram showing a voltage signal TP_TX at a transmitting end and a voltage signal TP_RX at a receiving end that are measured when no finger approaches.

FIG. 2B is a schematic diagram showing a voltage signal TP_TX at a transmitting end and a voltage signal TP_RX at a receiving end that are measured when a finger approaches.

FIG. 3 is a schematic diagram showing an active pen.

FIG. 4 is a schematic diagram showing an ID data segment of a Pen_TX signal.

FIG. 5 is a schematic diagram showing a touch display system in accordance with the present invention.

FIG. 6 is a flow chart of a touch display method in accordance with the present invention.

FIG. 7A is a schematic diagram showing an example of a driving signal of an active pen in accordance with the present invention.

FIG. 7B is a schematic diagram showing another example of a driving signal of an active pen in accordance with the present invention.

### DETAILED DESCRIPTION OF PREFERRED EMBODIMENTS

To make the objectives, technical schemes, and technical effects of the present invention more clearly and definitely, the present invention will be described in details below by using embodiments in conjunction with the appending drawings. It should be understood that the specific embodiments described herein are merely for explaining the present invention, and as used herein, the term “embodiment” refers to an instance, an example, or an illustration but is not intended to limit the present invention. In addition, the articles “a” and “an” as used in the specification and the appended claims should generally be construed to mean “one or more” unless specified otherwise or clear from the context to be directed to a singular form. Also, in the appending drawings, the components having similar or the same structure or function are indicated by the same reference number.

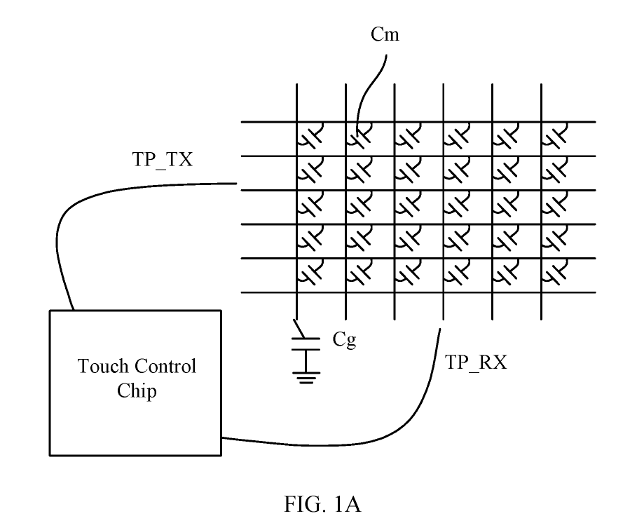

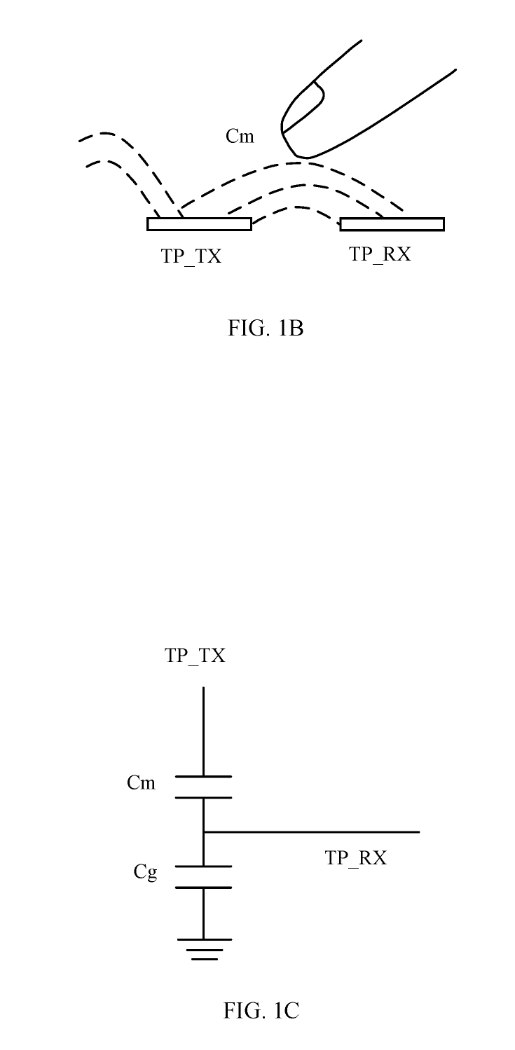

FIG. 1A is a schematic diagram showing a capacitive touch panel. FIG. 1B is a schematic diagram showing coupling capacitance formed between a TX electrode and a RX electrode on a capacitive touch panel. FIG. 1C is a schematic diagram showing a relation between coupling capacitance and ground capacitance on a capacitive touch panel.

As shown in FIG. 1A, the capacitive touch panel generally includes a plurality of electrodes arranged in a matrix and a plurality of conductive wires connecting to the electrodes. These electrodes are made of indium tin oxide (ITO) and have a bar or diamond shape. In mutual capacitance framework, these electrodes can be classified into driving electrodes and sensing electrodes. Correspondingly, the conductive wires can be classified into driving wires and sensing wires. The driving wires connect to the driving electrodes. The sensing wires connect to the sensing electrodes. Similar to the driving scheme adopted in an active matrix LCD, the driving scheme in the mutual capacitance framework basically is sequentially applying pulse voltage signals (TP_TX, where TP represents “Touch Panel”) to the driving electrodes through the driving wires and correspondingly, sequentially reading generated voltage signals (TP_RX, where TP represents “Touch Panel”) from the sensing electrodes through the sensing wires.

As shown in FIG. 1A and FIG. 1B, mutual capacitance Cm is formed between the driving electrode at a transmitting end (i.e., TX end) and the sensing electrode at a receiving end (i.e., RX end). As shown in FIG. 1A and FIG. 1C, ground capacitance Gg is formed between the sensing electrode at the RX end and ground. The mutual capacitance Cm is changed when a finger (or a similar item) approaches, thereby changing the voltage signals measured from the sensing electrodes.

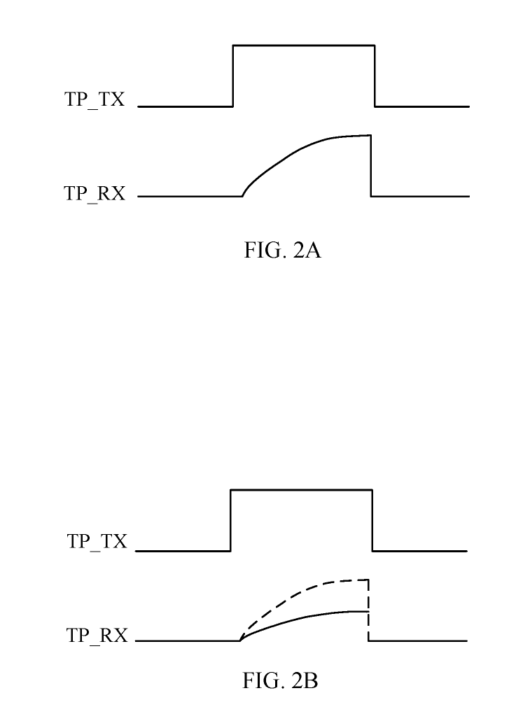

FIG. 2A is a schematic diagram showing a voltage signal TP_TX at the transmitting end and a voltage signal TP_RX at the receiving end that are measured when no finger approaches. FIG. 2B is a schematic diagram showing a voltage signal TP_TX at the transmitting end and a voltage signal TP_RX at the receiving end that are measured when a finger approaches.

As shown in FIG. 2A and FIG. 2B, when the finger approaches, the mutual capacitance Cm between the driving electrode and the sensing electrode is affected and thus decreases. Accordingly, the voltage signal TP_RX measured from the sensing electrode through the sensing wire decreases as well. A touch control chip is used to sequentially apply the voltage signal TP_TX to each driving electrode on the touch panel and sequentially read the voltage signal TP_RX from each sensing electrode on the touch panel. In this way, the touch control chip can resolve which points are touched and which points are not touched, so as to obtain the position of a touch event.

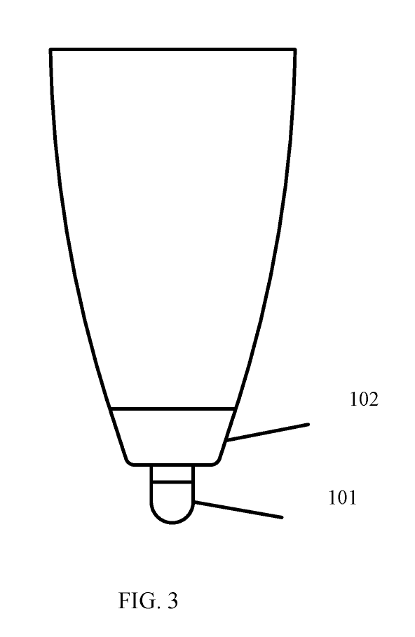

FIG. 3 is a schematic diagram showing an active pen. The active pen (e.g., a capacitive pen) can result in an effect on the capacitive touch panel, similar to the effect generated by touching the touch screen using the finger. The active pen can change the mutual capacitance Cm between the driving electrode and the sensing electrode on the touch screen. The principle of the active capacitive pen is described below. As shown in FIG. 3, the active capacitive pen has a signal transmitting portion (for generating a Pen_TX signal) 101 and a signal receiving portion (for generating a Pen_RX signal) 102 located at a tip of the pen. The signal receiving portion 102 is configured to sense the TP_TX signal generated by the touch panel to generate the Pen_RX signal. The signal transmitting portion 101 is configured to generate a driving signal (i.e., the Pen_TX signal) based on the Pen_RX signal generated by the signal receiving portion 102. When the Pen_RX signal generated by the signal receiving portion 102 exceeds a threshold (i.e., when the capacitive pen is close enough to the touch screen), the signal transmitting portion 101 will output the Pen_TX driving signal to affect the mutual capacitance Cm between the driving electrode and the sensing electrode on the touch screen and change its value.

In the present invention, the Pen_TX signal generated by the signal transmitting portion 101 of the active capacitive pen is divided into two segments. One of the two segments represents a position signal configured to inform touch control chip with information indicating which position is touched. The other one of the two segments represents an identification (ID) data signal configured to inform the touch control chip with an ID number of the capacitive pen. In this way, the touch control chip can detect a touched position and obtain the ID number of the capacitive pen. The ID number can be used to indicate a color, tip size, or type (e.g., pencil, ballpoint pen, marker pen) of the pen. That is, a comparison table may be deployed in the touch control chip. This table records the ID number of the capacitive pen and corresponding parameters (e.g., color of the pen). When the ID number of the capacitive pen is obtained, the touch control chip looks up the table and then transmits a color corresponding to the ID number to a display panel. Then, the display panel displays traces of the pen with the color.

Regarding to the position segment of the Pen_TX signal, the signal transmitting portion 101 will output a signal of which the intensity corresponds to the signal intensity (that is, the intensity of the Pen_RX signal) received by the signal receiving portion 102. That is, the higher the intensity of a received signal, the higher the intensity of a transmitted signal. This is to simulate a finger touch to make voltage variation similar to Gauss distribution, so as to calculate the coordinate of a touched point.

Regarding to the ID data segment of the Pen_TX signal, the capacitive pen will estimate the frequency of the TP_TX signal when receiving the TP_TX signal transmitted from the touch control chip. After outputting the position segment, the signal transmitting portion 101 of the capacitive pen will output a data signal segment representative of the ID data of the pen.

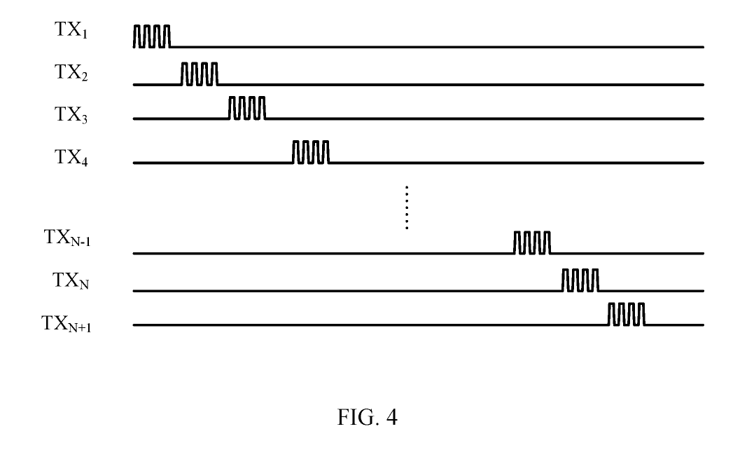

FIG. 4 is a schematic diagram showing the ID data segment of the Pen_TX signal. For example, as shown in FIG. 4, data bit “1” in the ID data segment may occupy a duration of about five TP_TX pulse signals and data bit “0” may occupy the same duration without transmitting the pulse signals. The TP_RX signal sensed by the touch control chip is shown in FIG. 4.

For example, the ID data signal has three data bits, which can be used to represent eight pens having different properties. For example, a capacitive pen with an ID data signal carrying “100” is a blue pen, a capacitive pen with an ID data signal carrying “101” is a red pen, and a capacitive pen with an ID data signal carrying “111” is a black pen.

The capacitive pens can carry different ID data signals. The capacitive pens may have different properties and are like traditional pens. The property of the active capacitive pen can be identified as long as the touch control chip cooperates with the active pen, without help of software. The active pen is comparable to a traditional marker or whiteboard pen. The usage of the active pen has no big change when it is compared to the usage of the traditional marker pen. This active pen is easily to be used by a user.

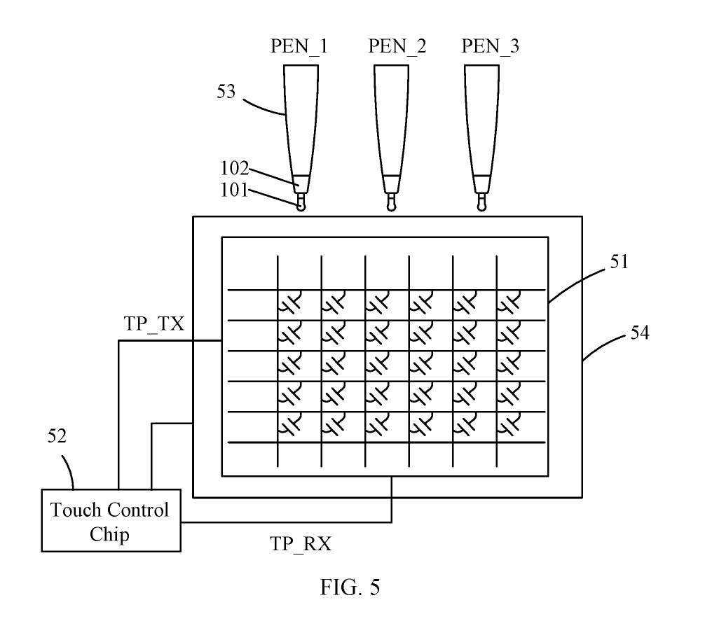

FIG. 5 is a schematic diagram showing a touch display system in accordance with the present invention. Based on the concept described above, the present invention provides a touch display system. As shown in FIG. 5, touch display system includes a touch panel 51, a touch control chip 52, an active pen 53, and a display panel 54. The touch panel 51 overlaps with the display panel 54. Also, the touch panel 51 can be integrated into the display panel 54. The active pen 53 can be the afore-mentioned active capacitive pen.

As described above, the touch panel 51 may include a plurality of driving electrodes and sensing electrodes arranged in a matrix and a plurality of conductive wires connecting to the driving electrodes and the sensing electrodes. The touch control chip 52 periodically transmits a driving signal TP_TX to the touch panel 51. The driving signal TP_TX is applied to the driving electrodes of the touch panel 51. A sensing signal TP_RX is generated on the touch panel 51. The touch control chip 52 receives the sensing signal TP_RX from the touch panel 51. Specifically, the sensing signal TP_RX is received from the sensing electrodes on the touch panel 51. The driving electrodes and the sensing electrodes may have diamond electrode structures.

The active pen includes a signal transmitting portion 101 and a signal receiving portion 102. The signal receiving portion 102 senses the driving signal TP_TX transmitted by the touch control chip 52 from the touch control chip 52 to the touch panel 51 to generate a sensing signal Pen_RX. When the active pen 53 determines that the sensing signal Pen_RX exceeds a threshold, the signal transmitting portion 101 of the active pen 53 transmits a driving signal Pen_TX. The driving signal Pen_TX includes two signal segments, called a position signal and an identification (ID) signal, herein. The position signal is configured to indicate the position of the active pen 51 on the touch panel 51. The ID signal carries an ID data of the active pen 53. In generating the ID signal, the signal transmitting portion 101 of the active pen 53 generates the ID signal based on the frequency of the driving signal TP_TX transmitted by the touch control chip 52.

In response to the driving signal Pen RX generated by the active pen 53, the touch panel 51 is induced to generate the sensing signal TP_RX. The touch control chip 52 receives the induced sensing signal TP_RX and resolves it to obtain the ID data representative of the ID signal. Also, the touch control chip 52 inquires a property of the active pen 53 corresponding to the ID data by looking up a table that records correspondence between the ID data and the property of the active pen 53. This table can be written to a ROM of the touch control chip 52. The property of the active pen 53 may include any one of color, tip size, and type of the active pen 53, or their combinations. The touch control chip 52 transmits the obtained property of the active pen 53 to the display panel 54. The display panel 54 receives the property of the active pen 53 from the touch control chip 52 and displays traces in accordance with the property of the active pen 53. For example, as shown in FIG. 5, PEN_1 indicates a blue pen, PEN_2 indicates a red pen, and PEN_3 indicates a black pen. Different ID data are carried by PEN_1, PEN_2, and PEN_3. For example, when the ID data of PEN_2 is detected by the touch control chip 52, the display panel 54 displays writing traces of PEN_2 with red color.

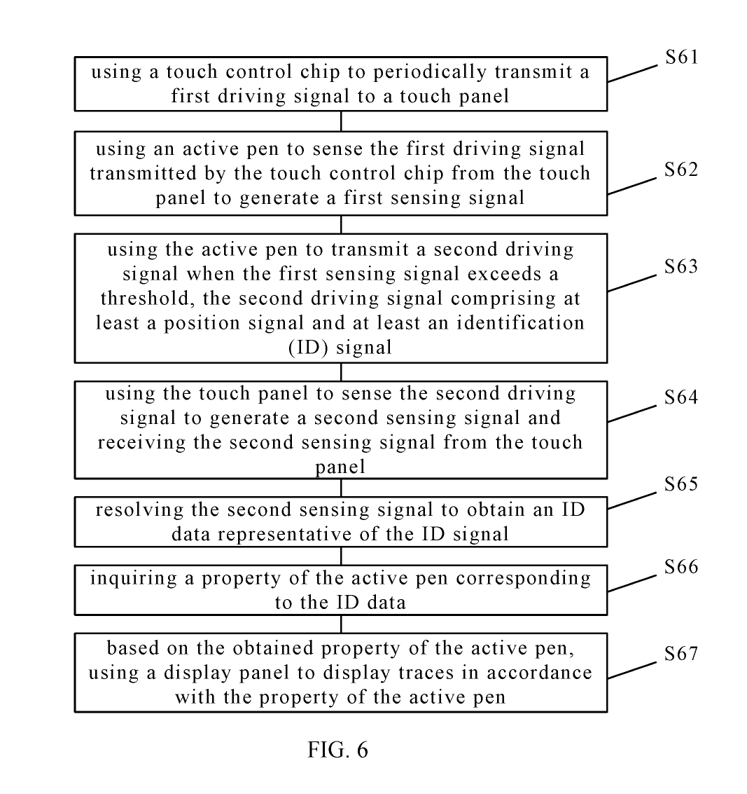

FIG. 6 is a flow chart of a touch display method in accordance with the present invention. Based on the concept described above, the present invention provides a touch display method. Referring to FIG. 6 in accompanying with FIG. 5, the touch display method of the present invention includes the following steps.

In Step S61, a touch control chip is used to periodically transmit a first driving signal to a touch panel.

In Step S62, an active pen is used to sense the first driving signal transmitted by the touch control chip from the touch panel to generate a first sensing signal.

In Step S63, the active pen is used to transmit a second driving signal when the first sensing signal exceeds a threshold. The second driving signal includes two signal segments that are called a position signal and an identification (ID) signal herein.

In Step S64, the touch panel is used to sense the second driving signal to generate a second sensing signal, and the second sensing signal is received from the touch panel.

In Step S65, the second sensing signal is resolved to obtain an ID data representative of the ID signal.

In Step S66, a property of the active pen corresponding to the ID data is inquired.

In Step S67, based on the obtained property of the active pen, a display panel is used to display traces in accordance with the property of the active pen.

The details of the touch display method of the present invention can be referred to the touch display technologies described above, and are not repeated herein.

In addition, the present invention further provides an active pen and a touch control device, and their details can be referred to the touch display system and the touch display method described above and are not repeated herein.

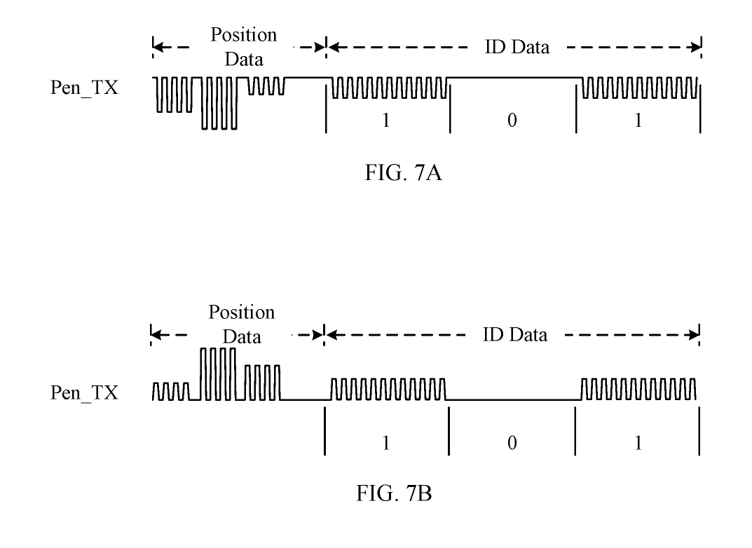

FIG. 7A is a schematic diagram showing an example of a driving signal of an active pen in accordance with the present invention. FIG. 7B is a schematic diagram showing another example of a driving signal of an active pen in accordance with the present invention.

The position signal of the driving signal Pen_TX transmitted by the active pen may have two forms, that is, a negative form shown in FIG. 7A and a positive form shown in FIG. 7B. In the negative form, the voltage of the sensing signal TP_RX received by the touch panel will drop. This is similar to the finger touch situation. In the negative form, it needs to use different thresholds to distinguish which one touches the touch screen, finger or pen, to handle the situation that the finger and the pen are used together. The positive form can be adopted in order to distinguish the finger and the pen in a better way. In the positive form, the voltage of the sensing signal TP_RX received by the touch panel will raise. Accordingly, it can be known that positive voltage values correspond to a pen touch and negative voltage values correspond to a finger touch.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

1. A touch display system, comprising:
a touch panel;
a touch control chip configured to periodically transmit a first driving signal to the touch panel;
an active pen comprising a signal transmitting portion and a signal receiving portion, the signal receiving portion configured to sense the first driving signal transmitted by the touch control chip from the touch panel to generate a first sensing signal, the signal transmitting portion configured to transmit a second driving signal when the first sensing signal exceeds a threshold, the second driving signal comprising at least a position signal and at least an identification (ID) signal, the touch panel configured to sense the second driving signal to generate a second sensing signal, the touch control chip configured to receive the second sensing signal from the touch panel, resolve the second sensing signal to obtain an ID data representative of the ID signal, and inquire a property of the active pen corresponding to the ID data; and
a display panel configured to receive the property of the active pen from the touch control chip and display traces in accordance with the property of the active pen.

2. The touch display system according to claim 1, wherein the touch panel comprises a plurality of driving electrodes and sensing electrodes arranged in a matrix and a plurality of conductive wires connecting to the driving electrodes and the sensing electrodes, and wherein the first driving signal transmitted from the touch control chip is applied to the driving electrodes and the second sensing signal is a signal received from the sensing electrodes by the touch control chip.

3. The touch display system according to claim 2, wherein the driving electrodes and the sensing electrodes comprises diamond electrode structures.

4. The touch display system according to claim 1, wherein the signal transmitting portion of the active pen transmits the ID signal of the second driving signal based on a frequency of the first driving signal transmitted by the touch control chip.

5. The touch display system according to claim 1, wherein the active pen comprises an active capacitive stylus.

6. The touch display system according to claim 1, wherein the property of the active pen is selected from a group consisting of color, tip size, and type of the active pen.

7. A touch display method, comprising:
using a touch control chip to periodically transmit a first driving signal to a touch panel;
using an active pen to sense the first driving signal transmitted by the touch control chip from the touch panel to generate a first sensing signal;
using the active pen to transmit a second driving signal when the first sensing signal exceeds a threshold, the second driving signal comprising at least a position signal and at least an identification (ID) signal;
using the touch panel to sense the second driving signal to generate a second sensing signal and receiving the second sensing signal from the touch panel;
resolving the second sensing signal to obtain an ID data representative of the ID signal;
inquiring a property of the active pen corresponding to the ID data; and
based on the obtained property of the active pen, using a display panel to display traces in accordance with the property of the active pen.

8. The touch display method according to claim 7, wherein in the step of using the active pen to transmit the second driving signal, the ID signal of the second driving signal is transmitted based on a frequency of the first driving signal.

9. The touch display method according to claim 7, wherein the step of inquiring the property of the active pen corresponding to the ID data comprises:
looking up a table that records correspondence between the ID data and the property of the active pen.

10. The touch display method according to claim 7, wherein the property of the active pen is selected from a group consisting of color, tip size, and type of the active pen.

11. An active pen, comprising:
a signal receiving portion configured to sensing a touch panel to generate a sensing signal; and
a signal transmitting portion configured to transmit a driving signal when the sensing signal exceeds a threshold, wherein the driving signal comprises a position signal and an identification (ID) signal which are two segments of the driving signal, and the ID signal is representative of an ID data corresponding to the active pen.

12. A touch control device, comprising:
a touch panel; and
a touch control chip configured to receive a sensing signal from the touch panel, the sensing signal generated by the touch panel, the touch control chip further configured to resolve the sensing signal to obtain an identification (ID) data of an active pen, and inquire a property of the active pen corresponding to the ID data.
